(19) United States
(12) Patent Application Publication
(10) Pub. No.: US 2025/0037629 A1
(43) Pub. Date: Jan. 30, 2025

(54) VEHICLE DISPLAY SYSTEM

(71) Applicant: CARUX TECHNOLOGY PTE. LTD., SINGAPORE (SG)

(72) Inventors: Yi-Cheng Chang, Tainan (TW); Chia-I Li, Tainan (TW)

(73) Assignee: CARUX TECHNOLOGY PTE. LTD., SINGAPORE (SG)

(21) Appl. No.: 18/747,304

(22) Filed: Jun. 18, 2024

(30) Foreign Application Priority Data
Jul. 27, 2023 (CN) 202310933755.6

(51) Int. Cl. G09G 3/00; G09G 3/34

(52) U.S. Cl. CPC G09G 3/006; G09G 3/3406; G09G 2320/0673; G09G 2380/10

(57) ABSTRACT

A vehicle display system is provided. The vehicle display system includes a display device and a control circuit. The display device includes a display panel and a plurality of first driving circuits. The first driving circuits are configured to drive the display panel. The control circuit is electrically connected to the plurality of first driving circuits. The control circuit is configured to provide register data of the first driving circuits. At least one of the first driving circuits receives and stores the register data temporarily, and checks the stored register data. When the stored register data fails the check, at least one of the first driving circuits reports a check result to the control circuit.

### CROSS-REFERENCE TO RELATED APPLICATION

This application claims the priority benefit of China application serial no. 202310933755.6, filed on Jul. 27, 2023. The entirety of the above-mentioned patent application is hereby incorporated by reference herein and made a part of this specification.

### BACKGROUND

### Technical Field

The disclosure relates to a vehicle display system.

### Description of Related Art

A control commands or an operating parameter of a driving circuit may be stored in a register or a random access memory (RAM), so that the driving circuit may perform a corresponding function according to the stored control command or operating parameter. If data of the control command or the operating parameter is incorrect, it may cause malfunction of the driving circuit.

In the prior art, the control command or operating parameter may be written into a register or a RAM of the driving circuits by an external control circuit, and a number of chips that the control circuit needs to control may be as many as 20 or more. The stored data may be rewritten due to unknown reasons, however, the control circuit cannot check whether the control command or operating parameter stored in the driving circuit is correct. If the control circuit reads back the control command or operating parameter from the driving circuit and then checks the read-back data, in an application situation of multiple driving circuits, the control circuit must spend a lot of time to read the data of the driving circuits. In this way, an operating time of the system will be increased.

### SUMMARY

The disclosure is directed to a vehicle display system, in which a plurality of driving circuits have a self-checking function, which ensures correctness of stored data and reduce a data reading time of a control circuit.

According to an embodiment of the disclosure, the vehicle display system includes a display device and a control circuit. The display device includes a display panel and a plurality of first driving circuits. The first driving circuits are used for driving the display panel. The control circuit is electrically connected to the plurality of first driving circuits. The control circuit is used for providing register data of the first driving circuits. At least one of the first driving circuits receives and temporarily stores the register data, and checks the register data. When the register data fails the check, at least one of the first driving circuits reports a check result to the

### BRIEF DESCRIPTION OF THE DRAWINGS

FIG. 1 is a schematic diagram of a vehicle display system according to an embodiment of the disclosure.

FIG. 2 is a schematic diagram of a control circuit and a first driving circuits according to an embodiment of the disclosure.

FIG. 3 is a schematic internal block diagram of a first driving circuit according to an embodiment of the disclosure.

FIG. 4 is a schematic diagram of register data according to an embodiment of the disclosure.

FIG. 5 is a schematic diagram of the register data according to another embodiment of the disclosure.

FIG. 6 is a schematic diagram of the register data according to another embodiment of the disclosure.

FIG. 7 is a schematic diagram of a control circuit, first driving circuits and a display panel according to an embodiment of the disclosure.

FIG. 8 is a schematic diagram of a control circuit, second driving circuits and a backlight module according to an embodiment of the disclosure.

FIG. 9 is a flowchart illustrating steps of a check method of a vehicle display system according to an embodiment of the disclosure.

FIG. 10 is a flowchart illustrating steps of a check method of a vehicle display system according to another embodiment of the disclosure.

### DESCRIPTION OF THE EMBODIMENTS

The disclosure may be understood by referring to the following detailed description in conjunction with the accompanying drawings. It should be noted that, in order to make the readers understand easily and for the sake of brevity of the drawings, several drawings in the disclosure only depict a part of an electronic device. Also, certain components in the drawings are not drawn to actual scales. In addition, a quantity and size of each component in the figure are only for illustration, and are not intended to limit a scope of the disclosure.

In the following description and claims, words such as “containing” and “including” are open-ended words, so they should be interpreted as meaning “containing but not limited to . . . ”.

Although the terms first, second, third . . . may be used to describe various components, the components are not limited to these terms. These terms are only used to distinguish a single component from other components in the specification. The same terms may not be used in the claims, and the components may be described as first, second, third components . . . according to an order declared in the claims. Therefore, in the following description, the first component may be the second component in the claims.

In some embodiments of the disclosure, terms related to bonding and connection, such as “connection” and “interconnection”, etc., unless otherwise specified, may mean that two structures are in direct contact, or may also mean that two structures are not in direct contact, and there are other structures located between these two structures. And the terms about bonding and connection may also include the situation that both structures are movable, or both structures are fixed. In addition, the term “couple” includes any direct and indirect electrical connection means.

In addition, the terms “a given range is from a first numerical value to a second numerical value” and “the given range falls within a range from the first numerical value to the second numerical value” mean that the given range includes the first numerical value, the second numerical value and other values there between. If a first direction is perpendicular to a second direction, an angle between the first direction and the second direction may be between 80 degrees and 100 degrees; if the first direction is parallel to the second direction, the angle between the first direction and the second direction may be between 0 degrees and 10 degrees. The terms “about”, “substantially” or “approximately” are generally interpreted as being within 10% of a given value or range, or as being within 5%, 3%, 2%, 1% or 0.5% of the given value or range. Reference will now be made in detail to the exemplary embodiments of the disclosure, examples of which are illustrated in the accompanying drawings. Wherever possible, the same reference numbers will be used in the drawings and description to refer to the same or like parts.

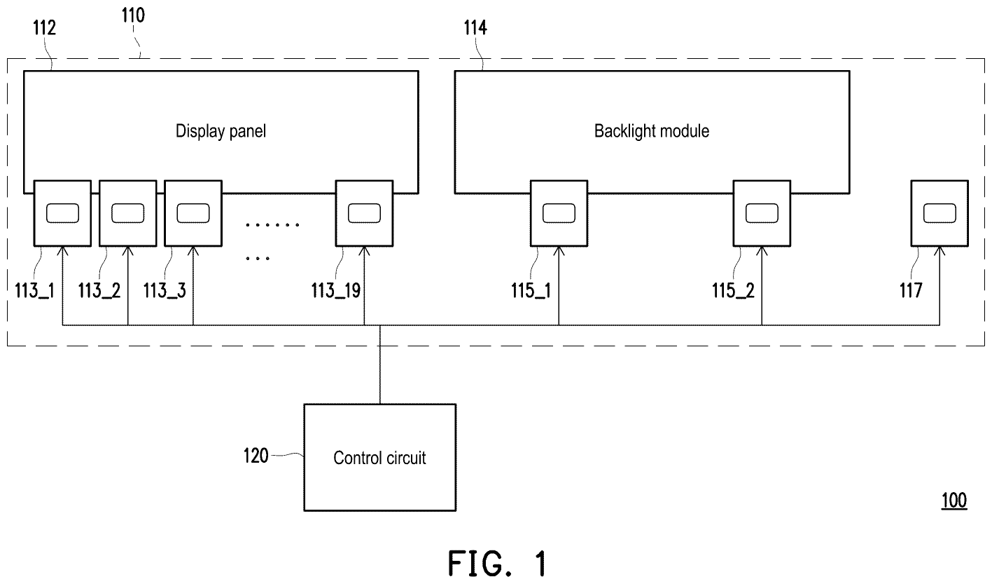

FIG. 1 is a schematic diagram of a vehicle display system according to an embodiment of the disclosure. Referring to FIG. 1, a vehicle display system 100 includes a display device 110 and a control circuit 120. The display device 110 includes a display panel 112, a plurality of first driving circuits 113_1, 113_2, 113_3, . . . , 113_19 (represented by 113 hereinafter), a backlight module 114, a plurality of second driving circuits 115_1, 115_2 (represented by 115 hereinafter), and a gamma correction circuit 117. The quantity and relative position of each component in FIG. 1 are not intended to limit the disclosure.

The first driving circuit 113 are, for example, display driving chips for driving the display panel 112 to display image frames. The second driving circuits 115 are, for example, backlight module driving chips for driving the backlight module 114 to output light. The gamma correction circuit 117 is, for example, a programmable gamma correction buffer circuit chip (P-Gamma chip), which is used to adjust a gamma voltage to make the color and resolution of the image displayed on the display panel 112 suitable for the user.

The control circuit 120 is electrically connected to the first driving circuits 113, the second driving circuits 115 and the gamma correction circuit 117. The control circuit 120 controls operations of the first driving circuits 113, the second driving circuits 115 and the gamma correction circuit 117. For example, the control circuit 120 may provide register data to the first driving circuits 113, the second driving circuits 115 and the gamma correction circuit 117. The register data includes control commands, which are used to control operations of the first driving circuits 113, the second driving circuit 115, and the gamma correction circuit 117, so that each circuit may perform corresponding functions, for example, to drive the display panel 112 to display image frames, to drive the backlight module 114 to output a light source and adjust the gamma voltage. The control circuit 120 includes a timing controller, a micro controller unit

(MCU) and/or a vehicle control unit (VCU). The register data will not be stored when the vehicle display system 100 is shut down or restarted.

In the embodiment, the first driving circuits 113, the second driving circuits 115 and the gamma correction circuit 117 may receive and temporarily store the register data provided by the control circuit 120, and check the register data to confirm correctness of the register data.

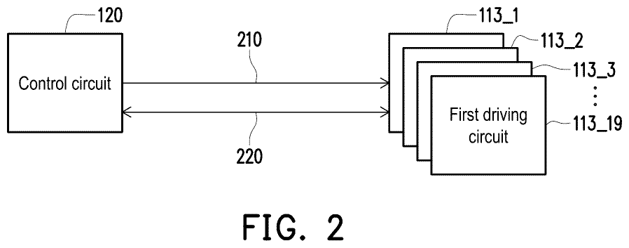

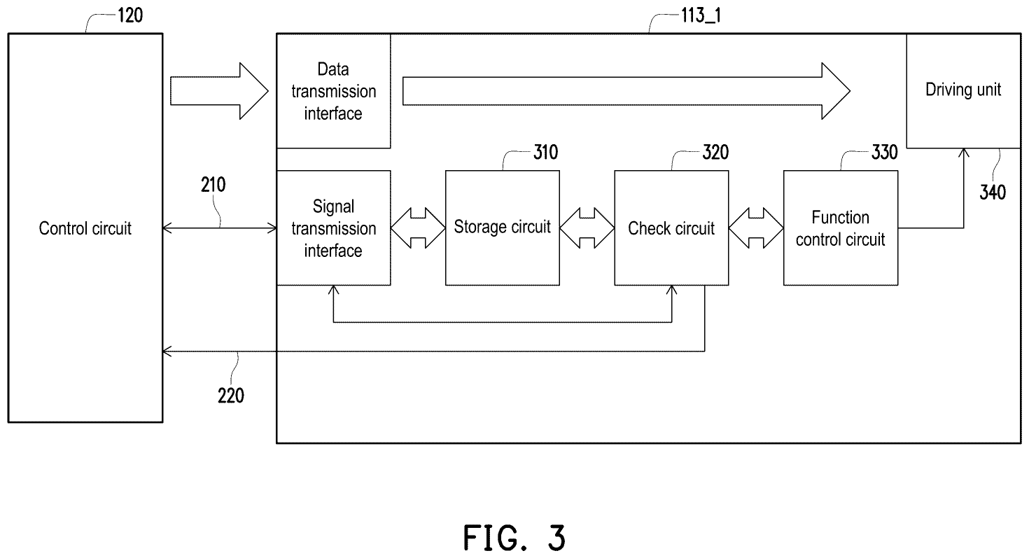

Specifically, taking the first driving circuits 113 as an example, FIG. 2 is a schematic diagram of the control circuit and the first driving circuits of the embodiment of the disclosure, and FIG. 3 is a schematic internal block diagram of a first driving circuit of the embodiment of the disclosure. Referring to FIG. 2 and FIG. 3, the first driving circuit 113_1 (at least one of the plurality of first driving circuits) receives the register data 210 from the control circuit 120 and temporarily stores the register data 210 in a storage circuit 310. The storage circuit 310 is, for example, a register or a random access memory (RAM).

Then, a check circuit 320 checks the register data 210 stored in the storage circuit 310 to confirm correctness of the register data 210. A method that the check circuit 320 checks the register data includes cyclic redundancy check (CRC), checksum, or other checking methods. When the register data 210 fails the check, the check circuit 320 may report the check result 220 to the control circuit 120. When the register data 210 passes the check, a function control circuit 330 may execute a corresponding function according to the control command of the register data 210.

For example, when the register data 210 to be written or already written into the storage

circuit 310 is incorrect or lost, the register data 210 may not pass the check of the check circuit 320. At this time, the check circuit 320 may report a check result 220 having an error flag to the control circuit 120. Then, after the control circuit 120 receives the check result 220, the control circuit 120 may again provide the register data 210 to the first driving circuit 113_1 reporting the check result. Taking the CRC method as an example, the register data 210 provided again by the control circuit 120 includes a recalculated CRC code. The CRC code is calculated before transmission or storage and is appended to the control command to serve as the register data 210, and then the first driving circuit 113_1 receives the register data 210 for checking to determine whether the data has changed.

Conversely, when the register data 210 to be written or already written into the storage circuit 310 is correct or not lost, the register data 210 may pass the check of the check circuit 320. At this time, the function control circuit 330 may execute the corresponding function according to the control command of the register data 210. For example, the function control circuit 330 controls the driving unit 340 to drive the corresponding data lines or pixels on the display panel 112 to display an image frame.

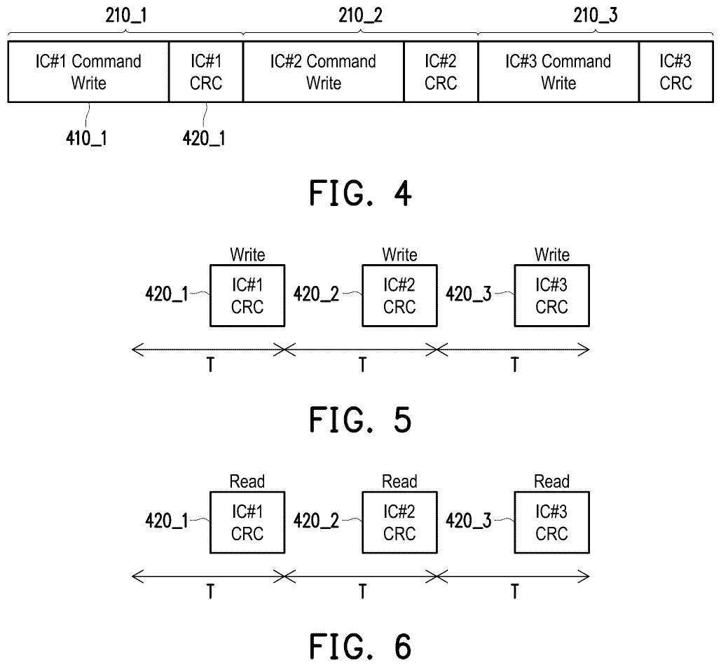

FIG. 4 is a schematic diagram of the register data according to an embodiment of the disclosure. Referring to FIG. 4, when writing data into the storage circuit 310, the control circuit 120 may simultaneously write the CRC code into the storage circuit 310. For example, FIG. 4 shows three pieces of register data 210_1, 210_2, 210_3 to be written into the first driving circuits 113_1, 113_2, 113_3 respectively. Taking the register data 210_1 as an example, the register data 210_1 includes a command 410_1 for controlling the operation of the first driving circuit 113_1 and a CRC code 420_1.

FIG. 5 is a schematic diagram of the register data according to another embodiment of the disclosure. Referring to FIG. 5, even if the control circuit 120 does not want to write data into the storage circuit 310, the control circuit 120 may also periodically (for example, a fixed time T) update the CRC codes 420_1, 420_2, 420_3 stored in the storage circuits 310 of the first driving circuit 113_1, 113_2, 113_3.

FIG. 6 is a schematic diagram of the register data according to another embodiment of the disclosure. Referring to FIG. 6, even if the control circuit 120 does not want to write data into the storage circuit 310, the control circuit 120 may also periodically (for example, the fixed time T) read the calculated and stored CRC codes 420_1, 420_2, 420_3 from the storage circuits 310 of the first driving circuit 113_1, 113_2, 113_3.

FIG. 4 to FIG. 6 take three first driving circuits 113_1, 113_2, and 113_3 as an example, and the register data of the other first driving circuits 113 may be deduced by analogy. In addition, FIG. 2 to FIG. 6 take the first driving circuits 113 as an example to illustrate the check method of the disclosure, and the check methods of the second driving circuits 115 and the gamma correction circuit 117 may be deduced in the same way.

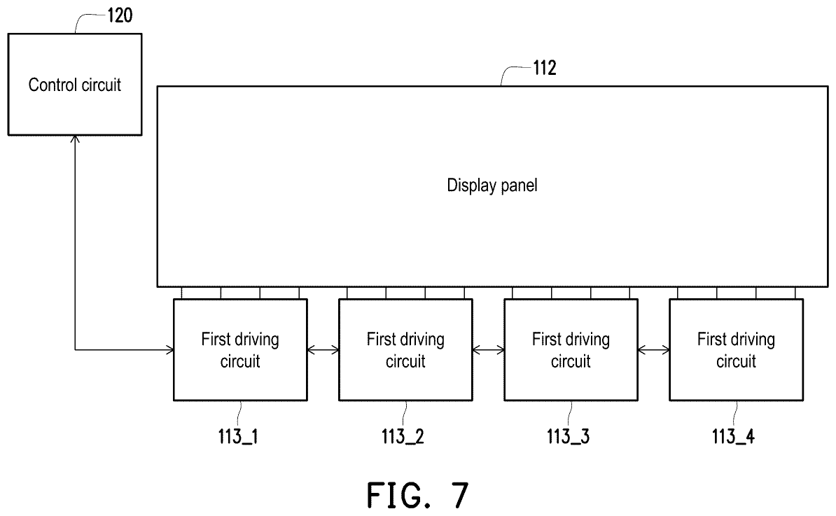

FIG. 7 is a schematic diagram of a control circuit, first driving circuits and a display panel according to an embodiment of the disclosure. Referring to FIG. 7, the embodiment takes the first driving circuits 113_1, 113_2, 113_3, 113_4 as an example for description, but the disclosure is not limited thereto. The embodiment is, for example, an embodiment applied to a vehicle computer. The control circuit 120 is a vehicle control unit, and the display panel 112 may include one or a plurality of display areas, which are driven by the first driving circuits 113_1, 113_2, 113_3, and 113_4 to display image frames. Data is transmitted between the first driving circuits 113_1, 113_2, 113_3, 113_4 and between the control circuit 120 and the first driving circuits 113_1, 113_2, 113_3, 113_4 by using a controller area network bus (CANBUS). The control circuit 120 outputs control commands to the first driving circuits 113_1, 113_2, 113_3, 113_4. The first driving circuits 113_1, 113_2, 113_3, and 113_4 respectively check the control commands. If the control commands fail to pass the check, the first driving circuits 113_1, 113_2, 113_3, 113_4 report check results to the control circuit 120. The way of checking by a storage terminal (i.e., the first driving circuit) may save the time for the control circuit 120 to read back data from all of the first driving circuits 113 and then perform checking.

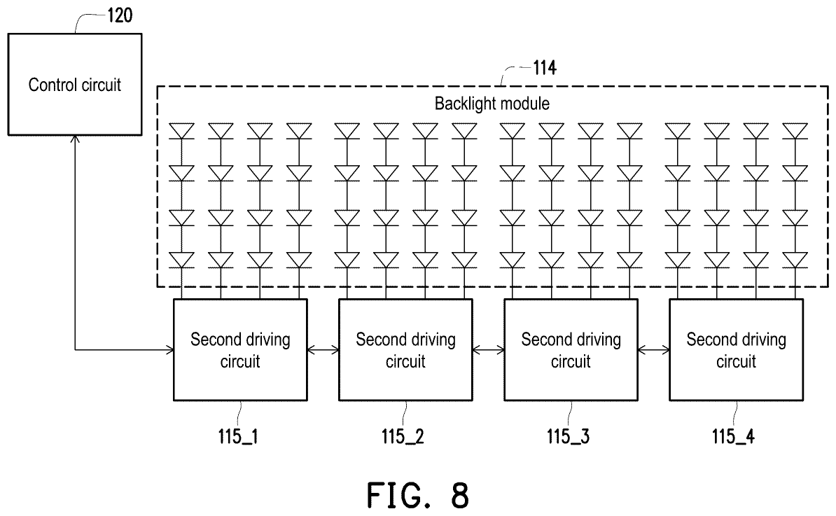

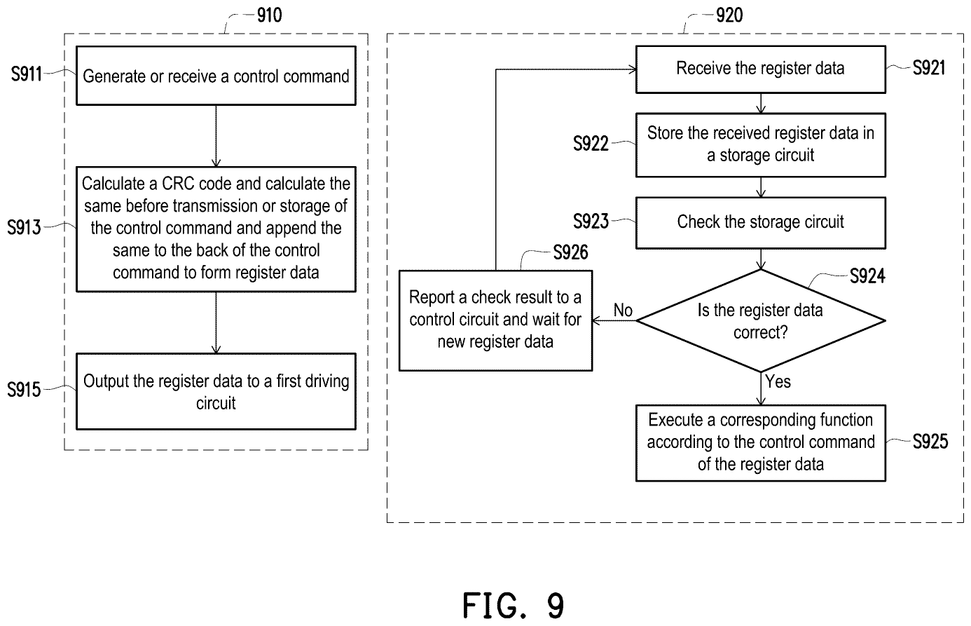

FIG. 8 is a schematic diagram of a control circuit, second driving circuits and a backlight module according to an embodiment of the disclosure. Referring to FIG. 8, the embodiment takes the second driving circuits 115_1, 115_2, 115_3, 115_4 as an example for description, but the disclosure is not limited thereto. The embodiment is, for example, an embodiment applied to a backlight module of micro LEDs or mini LEDs with a local dimming function, the control circuit 120 is a micro controller unit, and the backlight module may include one or a plurality of LED strings, which are driven by the second driving circuits 115_1, 115_2, 115_3, 115_4 to provide backlight. Data is transmitted between the second driving circuits 115_1, 115_2, 115_3, 115_4 and between the control circuit 120 and the second driving circuits 115_1, 115_2, 115_3, 115_4 through a serial peripheral interface (SPI). The control circuit 120 outputs control commands to the second driving circuits 115_1, 115_2, 115_3, and 115_4. The second driving circuits 115_1, 115_2, 115_3, and 115_4 respectively check the control commands. If the control commands fail to pass the check, the second driving circuits 115_1, 115_2, 115_3, 115_4 report the check results to the control circuit 120. The way of checking by a receiving terminal (i.e., the second driving circuit) may save the time for the control circuit 120 to read back data from the second driving circuits 115 and then perform checking.

FIG. 9 is a flowchart illustrating steps of a check method of a vehicle display system according to an embodiment of the disclosure. Referring to FIG. 9, the embodiment takes the CRC method as an example, but the disclosure is not limited thereto. A process 910 shows method steps when the control circuit 120 is used as a data output terminal, and a process 920 shows method steps of the data checking when the first driving circuits 113 are used as data storage terminals.

In step S911, the control circuit 120 generates or receives a control command. In step S913, the control circuit 120 calculates a CRC code and calculates the same before transmission or storage of the control command and appends the same to the back of the control command to form register data to be output to the first driving circuit 113. In step S915, the control circuit 120 outputs the register data to the first driving circuit 113.

In step S921, the first driving circuit 113 receives the register data. In step S922, the first driving circuit 113 stores the received register data in the storage circuit 310. Register data includes the control command and the CRC code. In an embodiment, even if the control circuit 120 does not want to write data into the storage circuit 310, the control circuit 120 may also periodically (for example, a fixed time T) update the CRC code stored in the storage circuit 310 of the first driving circuit 113. In step S923, the register data is checked by the check circuit 320 of the first driving circuit 113 to determine whether the data has changed.

In step S924, when the register data in the storage circuit 310 is correct or not lost, the register data may pass the check of the check circuit 320. At this time, in step S925, the function control circuit 330 may execute a corresponding function according to the control command of the register data.

In step S924, when the register data of the storage circuit 310 is incorrect or lost, the register data may fail to pass the check of the check circuit 320. At this time, in step S926, the check circuit 320 may report a check result with an error flag to the control circuit 120, and waits for new register data. The new register data includes a CRC code recalculated by the control circuit 120.

Therefore, in the embodiment, whether the register data is correct or not is checked by each first driving circuit serving as a data storage terminal, which saves the time for the control circuit to read back data from all of the first driving circuits and then perform checking.

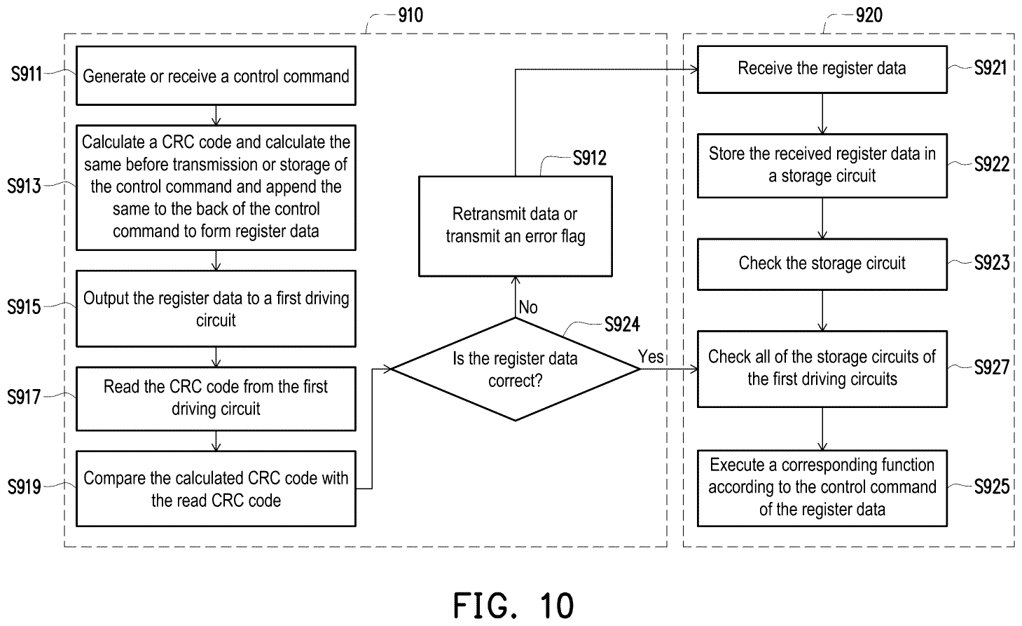

FIG. 10 is a flowchart illustrating steps of a check method of a vehicle display system according to another embodiment of the disclosure. Referring to FIG. 10, the embodiment takes the CRC method as an example, but the disclosure is not limited thereto.

In the process 910 of FIG. 10, steps S912, S917, S919, and S924 are further included. In step S917, the control circuit 120 reads the CRC code from the first driving circuit 113 to confirm that the CRC code is consistent with a value of an output terminal (such as the control circuit 120). Then, in step S919, the control circuit 120 compares the calculated CRC code with the read CRC code. If the data is wrong after the comparison, the control circuit 120 may retransmit the data or transmit an error flag, i.e., step S912.

In the process 920 of FIG. 10, step S927 is further included to confirm correctness of the data in the storage circuit 310 before performing step S925. In step S927, all of the storage circuits 310 of the first driving circuits 113 are checked by the check circuit 320.

In addition, FIG. 9 and FIG. 10 take the first driving circuits 113 as an example to illustrate a check method of the disclosure, and the check method of the second driving circuits 115 and the gamma correction circuit 117 may be deduced in the same way.

In summary, in the embodiments of the disclosure, each driving circuit may check whether the register data is correct by itself, and the control circuit does not need to read back the register data from each driving circuit for checking. Each driving circuit may check the correctness of the register data in real time, thereby reducing a workload of the control circuit.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A vehicle display system, comprising:
a display device, comprising a display panel and a plurality of first driving circuits, wherein the plurality of first driving circuits are configured to drive the display panel; and
a control circuit, electrically connected to the plurality of first driving circuits, and configured to provide register data,
wherein at least one of the plurality of first driving circuits receives and temporarily stores the register data and checks the register data, and the at least one of the plurality of first driving circuits reports a check result to the control circuit when the register data fails a check.

2. The vehicle display system according to claim 1, wherein when the register data passes the check, the at least one of the plurality of first driving circuits executes a corresponding function.

3. The vehicle display system according to claim 1, wherein the control circuit again provides the register data to the at least one of the plurality of first driving circuits that reports the check result after the control circuit receives the check result.

4. The vehicle display system according to claim 1, wherein the display device further comprises a backlight module and a plurality of second driving circuits, and the plurality of second driving circuits are configured to drive the backlight module,
wherein the control circuit is electrically connected to the plurality of second driving circuits and configured to provide the register data.

5. The vehicle display system according to claim 4, wherein data is transmitted between the plurality of second driving circuits and between the control circuit and the plurality of second driving circuits through a serial peripheral interface.

6. The vehicle display system according to claim 1, wherein the display device further comprises a gamma correction circuit,
wherein the control circuit is electrically connected to the gamma correction circuit and configured to provide the register data.

7. The vehicle display system according to claim 1, wherein data is transmitted between the plurality of first driving circuits and between the control circuit and the plurality of first driving circuits through a controller area network bus.

8. The vehicle display system according to claim 1, wherein the control circuit comprises a timing controller, a micro controller unit or a vehicle control unit.

9. The vehicle display system according to claim 1, wherein a check method used by one of the plurality of first driving circuits comprises cyclic redundancy check or checksum.

10. The vehicle display system according to claim 1, wherein the register data is not stored after the vehicle display system is shut down or restarted.

11. An operating method of a vehicle display system, wherein the vehicle display system comprises a display device and a control circuit, the display device comprises a display panel and a plurality of first driving circuits, and the plurality of first driving circuits are configured to drive the display panel, the operating method comprising:
providing register data to the plurality of first driving circuits through the control circuit;
receiving and temporarily storing the register data and checking the register data through at least one of the plurality of first driving circuits; and
reporting a check result to the control circuit through the at least one of the plurality of first driving circuits when the register data fails a check.

12. The operating method of the vehicle display system according to claim 11, wherein a corresponding function is executed through the at least one of the plurality of first driving circuits when the register data passes the check.

13. The operating method of the vehicle display system according to claim 11, wherein the method further comprises again providing the register data to the at least one of the plurality of first driving circuits that reports the check result through the control circuit after the check result is received.

14. The operating method of the vehicle display system according to claim 11, wherein the display device further comprises a backlight module and a plurality of second driving circuits, and the plurality of second driving circuits are configured to drive the backlight module,
wherein the operating method further comprises providing the register data to the plurality of second driving circuits through the control circuit.

15. The operating method of the vehicle display system according to claim 14, wherein data is transmitted between the plurality of second driving circuits and between the control circuit and the plurality of second driving circuits through a serial peripheral interface.

16. The operating method of the vehicle display system according to claim 11, wherein the display device further comprises a gamma correction circuit,
wherein the operating method further comprises providing the register data to the gamma correction circuit through the control circuit.

17. The operating method of the vehicle display system according to claim 11, wherein data is transmitted between the plurality of first driving circuits and between the control circuit and the plurality of first driving circuits through a controller area network bus.

18. The operating method of the vehicle display system according to claim 11, wherein the control circuit comprises a timing controller, a micro controller unit or a vehicle control unit.

19. The operating method of the vehicle display system according to claim 11, wherein a check method used by one of the plurality of first driving circuits comprises cyclic redundancy check or checksum.

20. The operating method of the vehicle display system according to claim 11, wherein the register data is not stored after the vehicle display system is shut down or restarted.
